(19) United States
(12) Patent Application Publication
(10) Pub. No.: US 2006/0005222 A1
(43) Pub. Date: Jan. 5, 2006

(54) Television broadcast receiving apparatus, system and method having separate display area for displaying an enlarged portion of web page while simultaneously displaying web page at a predetermined aspect ratio

(75) Inventor: Takashi Sato, Tokyo (JP)

Correspondence Address: FOLEY & LARDNER, 2029 CENTURY PARK EAST, SUITE 3500, LOS ANGELES, CA, 90067, US

(73) Assignee: KABUSHIKI KAISHA TOSHIBA

(21) Appl. No.: 11/014,296

(22) Filed: Dec. 15, 2004

(30) Foreign Application Priority Data
Jun. 30, 2004 (JP) 2004-192405

(51) Int. Cl. G06F 13/00

(52) U.S. Cl. 725/51

(57) ABSTRACT

A TV broadcast receiving apparatus has a display panel for displaying TV content at a predetermined aspect ratio. The apparatus also receives web content and displays the web content at the predetermined aspect ratio. In response to a user designation of an information area to be enlarged, the apparatus displays an enlarged image of the designated information area on an area of the display screen not being used to display the web content while simultaneously displaying the web content at the predetermined aspect ratio. Other embodiments include a first display and a second, transparent display wherein user designated information on the first display is enlarged and displayed on the second display which at least partially overlaps the first display.

### CROSS-REFERENCE TO RELATED APPLICATIONS

This application is based upon and claims the benefit of priority from prior Japanese Patent Application No. 2004-192405, filed Jun. 30, 2004, the entire contents of which are incorporated herein by reference.

### BACKGROUND OF THE INVENTION

1. Field of the Invention

The present invention relates to a television broadcast receiving apparatus, a television broadcast receiving system and a display control method for controlling a web page display.

2. Description of the Related Art

When a user reviews a web content by a display device of a computer, the user normally performs the operation to input various data and commands by using an input device while reviewing a character and a figure of the web content displayed on the display device.

In recent years, since a computer network has widely prevailed, it has been strongly desired to enlarge a character or the like of the web content displayed on the display device of the computer so that the user can easily recognize details of the web content.

As such an applied apparatus, for example, U.S. Patent Application Publication No. US 2001/0054049 A1 discloses an information processing system which displays the details of a document of the web content or the like on a display condition such as desired font size, line spacing, and character spacing without disturbing the original layout of the web content.

According to the above mentioned apparatus, weighting is performed for the contents of a document such as the web content displayed on the display device, and then the important phrases (characters) are enlarged and the phrases (characters) with low weight are deleted on the basis of the weighting to make a summary. Thus, the above mentioned apparatus prevents the overall layout of the web page from being disturbed.

However, according to the above mentioned apparatus, the user reviews the web page in which the parts with low weight has been already deleted by the display device. Therefore there is a possibility that the important parts for the user are deleted before the user reviews the content, because it is not clear that these deleted parts are really unnecessary for the user.

### BRIEF SUMMARY OF THE INVENTION

An embodiment of the present invention provides a television broadcast receiving apparatus, a television broadcast receiving system and a display control method which can enlarge the display content of the web page without disturbing the layout of the web page and without deleting the display information in the web page so that the user can easily recognize the web content.

According to an embodiment of present invention there is provided a TV broadcast receiving apparatus, connected to a display device having a screen panel, for displaying an image screen according to the received TV broadcast channel on the screen panel of said display device at a predetermined aspect ratio. The apparatus has a receiving unit for receiving a web content from an external server via a communication network a generating unit for generating a browser screen according to the content that is received by said receiving unit; and controller for controlling the display information that is designated to be enlarged by a user on the displayed browser screen, such that the enlarged information is displayed on a display area where the browser screen is not displayed in the screen panel while simultaneously displaying the browser screen generated by said generating unit at the predetermined aspect ratio.

According to yet another embodiment of present invention there is provided a TV broadcast receiving system having a TV broadcast receiving apparatus, for receiving a TV broadcast channel signal and a display device having a first display panel which displays an image screen according to the received TV broadcast channel signal and a second transparent display panel that is disposed at a position at least partially overlapping the first display panel and displays the character information. The system has a receiving unit for receiving a web content from an external server via a communication network; a generating unit for generating a browser screen according to the content that is received by the receiver unit; and a controller for controlling the browser screen generated by said generating unit to be displayed on said first display panel, and controlling the display information designated by a user on said browser screen displayed on said first display panel when an instruction for enlarging is inputted from the user and displayed on the second display panel.

According to yet another embodiment of present invention, a display control method is provided in a TV broadcast receiving apparatus which is connected to a display device having a screen panel for displaying an image screen according to a received TV broadcast channel at a predetermined aspect ratio. The method includes generating a browser screen according to the web content that is received from an external server via a communication network; displaying the generated browser screen on said screen panel at the predetermined aspect ratio; controlling the display information to be enlarged and that is designated by a user on the displayed browser screen; and displaying the enlarged display information on a display area where the browser screen is not displayed in the screen panel.

According to another embodiment of present invention, a display control method is provided in a TV broadcast receiving system having a TV broadcast receiving apparatus, connected to the TV service receiving apparatus, for receiving a TV broadcast channel signal and a display device having a first display panel which displays an image screen according to the received TV broadcast channel signal and a second transparent display panel that is disposed at a position at least partially overlapping the first display panel and displays character information. The method includes generating a browser screen according to web content that is received from an external server via a communication network; displaying the generated browser screen on said first display panel, and enlarging the information designated by a user on the browser screen displayed on the first display panel so that the enlarged information is displayed on the second display panel.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention in which:

FIG. 1 is a block diagram of a TV broadcast receiving system A including a Television broadcast receiving apparatus according to an embodiment of the present invention;

FIG. 2 is a block diagram showing an embodiment of the configuration of a TV broadcast receiving apparatus 12;

FIG. 3 is a schematic view showing an embodiment of an appearance and key arrangement of a remote controller 16;

FIG. 4 is a front view showing the TV broadcast receiving system A that a television image is displayed on a monitor 13;

FIGS. 5A and 5B are views showing an example of a screen of a web content displayed on the monitor 13;

FIG. 6 is a view showing an example of an enlarged screen of the web content displayed on the monitor 13;

FIG. 7 is a front view showing the TV broadcast receiving system A that the web content is displayed on other example of the monitor 13;

FIGS. 8A and 8B are views showing an example of an enlarged screen of the web content displayed on the monitor 13 shown in FIG. 7;

FIGS. 9A and 9B are views showing another example of an enlarged screen of the web content displayed on the monitor 13 shown in FIG. 7;

FIG. 10 is a view showing other example of an enlarged screen of the web content displayed on the monitor 13 shown in FIG. 7;

FIG. 11 is a flowchart showing a processing method for enlarging the details of the web content performed by the TV broadcast receiving apparatus 12;

FIG. 12 is a view showing an example of an enlarged screen of the bitmap image information in the web content displayed on the monitor 13;

FIG. 13 is a view showing other example of an enlarged screen of the bitmap image information in the web content displayed on the monitor 13;

FIG. 14 is a flowchart showing a processing method for enlarging the above-described bitmap image information in the web content performed by the TV broadcast receiving apparatus 12;

FIGS. 15A and 15B are views showing other example of an enlarged screen of the bitmap image information in the web content displayed on the monitor 13;

FIGS. 16A and 16B are views showing other example of an enlarged screen of the bitmap image information in the web content displayed on the monitor 13;

FIG. 17 is a flowchart showing other processing method for enlarging the above-described bitmap image information in the web content performed by the TV broadcast receiving apparatus 12;

FIG. 18 is a block diagram showing an embodiment of the configuration of a TV broadcast receiving apparatus 60;

FIG. 19 is a view showing a screen of a web content displayed on the monitor 13 shown in FIG. 18;

FIG. 20 is a view showing an example of an display screen on which the web content is displayed on a screen panel 63a and which the character information is enlarged on a transparent panel 63b;

FIG. 21 is a view showing other example of an display screen on which the web content is displayed on a screen panel 63a and which the character information is enlarged on a transparent panel 63b; and

FIG. 22 is a flowchart showing a processing method for enlarging the above-described character information which is selected in the web content performed by the TV broadcast receiving apparatus 60.

### DETAILED DESCRIPTION OF THE INVENTION

Embodiments of the invention will be described with reference to the accompanying drawings.

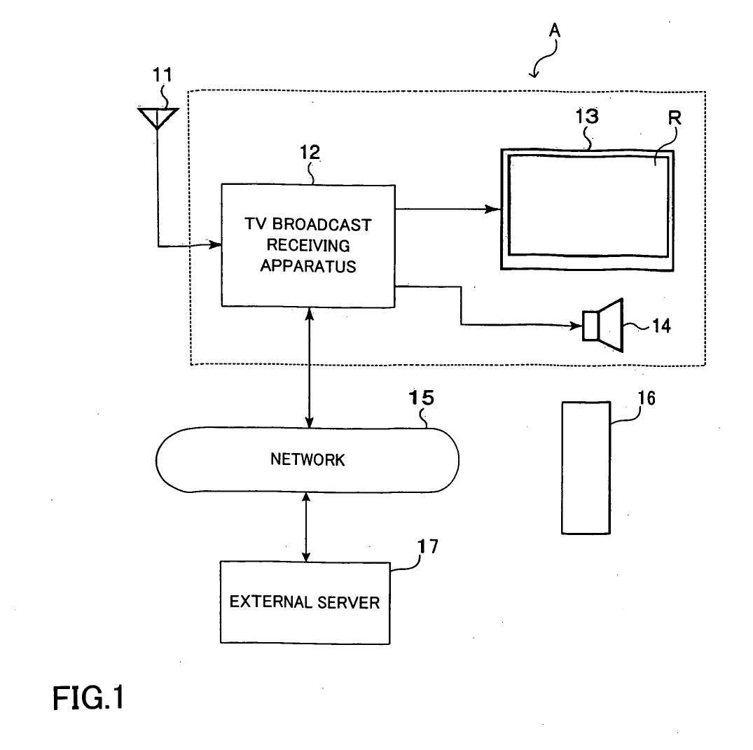

FIG. 1 shows is a block diagram of a TV broadcast receiving system A including a television broadcast receiving apparatus 12 according to an embodiment of the present invention.

As shown in FIG. 1, the TV broadcast receiving system A is configured by an antenna 11, a TV broadcast receiving apparatus 12, a monitor 13 as a display device, and a speaker 14. In addition, a remote controller 16 is further provided, whereby the user indicates various operations of the TV broadcast receiving apparatus 12 by remote control.

The antenna 11 receives airwaves and outputs TV broadcast signal to the TV broadcast receiving apparatus 12. The TV broadcast receiving apparatus 12 generates the original image signal and sound signal by performing channel selection processes and decoding processes or the like to the inputted TV broadcast signal.

The TV broadcast receiving apparatus 12 supplies the decoded image signal to the monitor 13 and supplies the decoded sound signal to the speaker 14. The monitor 13 displays the inputted image signal and the speaker 14 reproduces the inputted sound signal.

The TV broadcast receiving apparatus 12 is connected to a network 15 such as the Internet. The TV broadcast receiving apparatus 12 obtains the desirable information from an external server 17 by accessing the network 15, and then supplies the image component of the obtained information to the monitor 13, and supplies the sound component thereof to the speaker 14.

When the TV broadcast receiving apparatus 12 receives the instruction to access the network from the user while receiving a prescribed TV broadcast channel, the TV broadcast receiving apparatus 12 switches access to the network 15, and then displays the image component of the information such as the web content that is obtained from the network 15 on the monitor 13, and reproduces the sound component thereof at the speaker 14.

In addition, when the TV broadcast receiving apparatus 12 receives the instruction for the TV broadcast channel from the user while accessing the network 15, the TV broadcast receiving apparatus 12 generates the original image signal and sound signal by performing channel selection processes and decoding processes or the like of the instructed inputted TV broadcast channel to the inputted TV broadcast signal. Then the monitor 13 displays the decoded image signal and the speaker 14 reproduces the decoded sound signal.

As described above, the TV broadcast receiving apparatus 12 according to the present embodiment can switch to any one of the display of the TV broadcast channel and the display of the web content information. Furthermore, not limited to this, as described later, the TV broadcast receiving apparatus 12 can display two screens simultaneously side-by-side, including the TV broadcast channel on one screen and the web content information on the other screen.

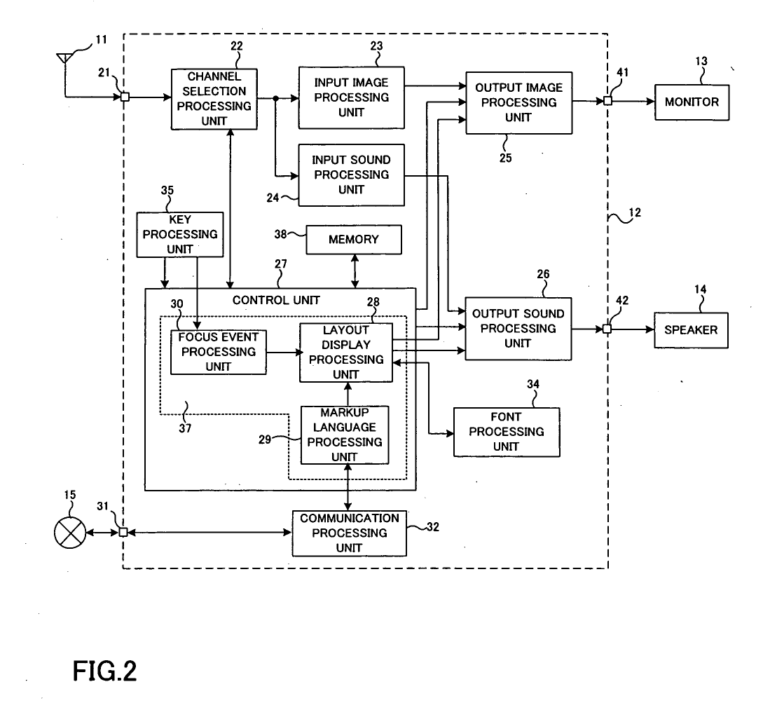

FIG. 2 is a block diagram showing an embodiment of the configuration of a TV broadcast receiving apparatus 12. As shown in FIG. 2, in the TV broadcast receiving apparatus 12, the TV broadcast signals that are received by the antenna 11 are supplied to a channel selection processing unit 22 via an input terminal 21.

This channel selection processing unit 22 selects the TV signal of a desirable broadcast channel from the inputted TV broadcast signals, and outputs this selected TV signal to an input image processing unit 23 and an input sound processing unit 24, respectively.

The input image processing unit 23 performs the decode processing to the image component of the inputted TV signal, and then outputs the image signal decoded in fields or frames to an output image processing unit 25. The input sound processing unit 24 performs the decode processing to the sound component of the inputted TV signal, and then outputs the decoded sound signal to an output sound processing unit 26.

A control unit 27 controls all operations of the TV broadcast receiving apparatus 12 including the operations to be described later generally. The control unit 27 is connected to a key processing unit 35. The control unit 27 receives the operation information inputted from the key processing unit 35 and controls each circuit so that the operation contents are reflected thereon.

The control unit 27 has a web browser processing unit 37. The control unit 27 can perform various processing in the web browser processing unit 37 by starting up HTML (Hypertext Markup Language) software that is stored in a memory 38, and can display the image signal forming the browser screen on the monitor 13 via the output image processing unit 25.

The web browser processing unit 37 has a layout display processing unit 28, a markup language processing unit 29, and a focus event processing unit 30. The web browser processing unit 37 decodes the web content that is described by the markup language and reproduces the layout. The web browser processing unit 37 generates the access request to the network 15 and transmits the access request to the network 15 via a communication processing unit 32 and a connection terminal 31.

The web content obtained from the network 15 is supplied to a markup language processing unit 29 via the connection terminal 31 and the communication processing unit 32. The markup language processing unit 29 performs a process of analyzing the markup language of the inputted web content, and then outputs the analysis result to the layout display processing unit 28.

The layout display processing unit 28 determines layout coordinates on the basis of the inputted analysis result. Then the layout display processing unit 28 generates a bitmap image signal to be displayed, and outputs it to the output image processing unit 25. The layout display processing unit 28 generates a sound signal such as a sound effect, and outputs it to the output sound processing unit 26.

The layout display processing unit 28 is connected to a font processing unit 34. The layout display processing unit 28 reads the font processing unit 34 to draw the characters when the layout display processing unit 28 generates a bitmap image signal.

The focus event processing unit 30 is connected to the key processing unit 35 to judge the operation information on the basis of the key information that is inputted from an operation part (not illustrated) and/or the remote controller 16. The operation part may be understood to duplicate most of the main operator selectable functions provided on the remote controller 16, but the operation part is physically a part of the TV broadcasting receiving apparatus 12.

The focus event processing unit 30 outputs the information relating to change of the layout in response to the operation information that is inputted from the key processing unit 35 to the layout display processing unit 28.

When the operation information in response to, for example, a move key (upper, lower, right and left key) 108 of the remote controller 16 is inputted from the operation processing unit 35, the focus event processing unit 30 extracts an element that is a target to be enlarged and then outputs this extracted information and the information to designate this enlargement to the layout display processing unit 28.

When the extracted information from the focus event processing unit 30 is inputted, the layout display processing unit 28 determines the layout coordinates that are changed so as to enlarge the parts corresponding to the extracted information among the layout coordinates on the basis of the analysis result inputted from the markup language processing unit 29, and then generates the bitmap information to be displayed.

The output image processing unit 25 converts the bitmap information that is supplied from the layout display processing unit 28 into an image signal. Then, the output image processing unit 25 selectively outputs the image signal supplied from the input image processing unit 23 and the image signal of which bitmap information is converted to the monitor 13 via an output terminal 41 (or may superimpose both image signals) to display the image.

The output sound processing unit 26 selectively outputs the sound signal supplied from the input sound processing unit 24 and the sound signal supplied from the layout display processing unit 28 to the speaker 14 via an output terminal 42 (or may superimpose both sound signals) to reproduce the sound.

The memory 38 is configured as a read only memory storing a control program to be executed by the control unit 27 therein, a random access memory for providing an operational area to the control unit 27, and a nonvolatile memory storing various setting information and control information therein or the like.

According to the present embodiment, the memory 38 stores an aspect ratio upon displaying the TV broadcast channel and the web content information, the setting information related to the enlarging area upon enlarging a portion of a browser screen to be described later, the information related to a reduction ratio of the image signal configuring the browser screen, or the information related to the moving display upon displaying the browser screen while displacing it.

With respect to the aspect ration, if a width and height ratio of a screen panel provided on the monitor 13 is width 4: height 3, the aspect ratio 4:3 is set in the memory 38. Therefore when the browser screen is reduced, the reduction processing is performed so as to maintain the aspect ratio of 4:3.

On the other hand, if the width and height ratio of the screen panel set in the monitor 13 is width 16: height 9, that is the width ratio of a wide TV size, the aspect ratio 16:9 is set in the memory 38. Therefore when the browser screen is reduced, the reduction processing is performed so as to maintain the aspect ratio of 16:9.

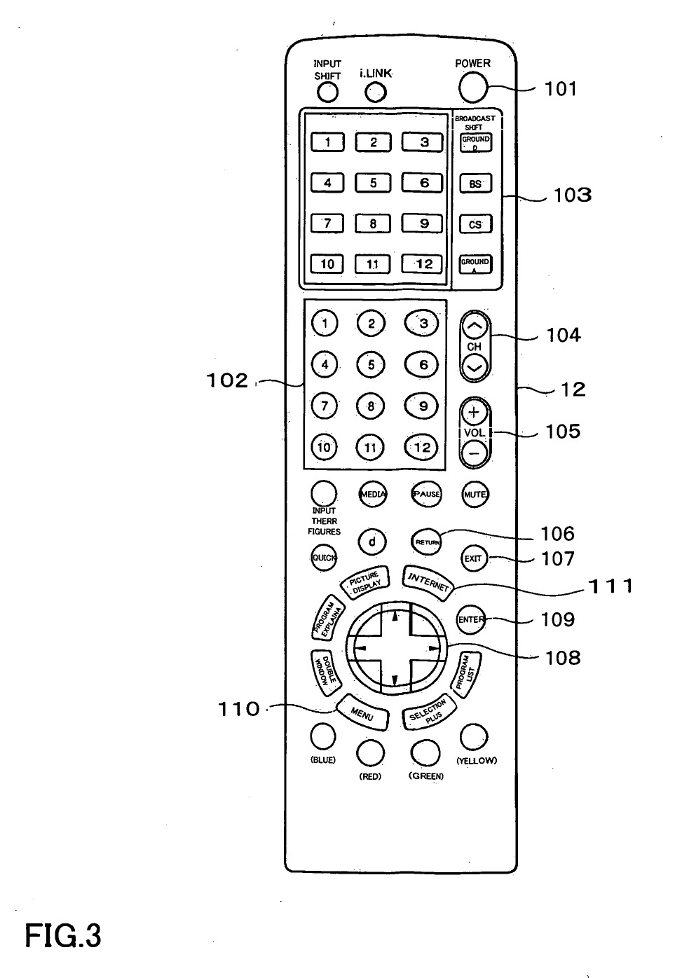

FIG. 3 is a schematic view showing an embodiment of an appearance and key arrangement of a remote controller 16. As shown in FIG. 3, the remote controller 16 has, for example, a power source key 101, a one-touch channel selection key group 102, a receiving mode shift key group 103, a channel up down key 104, a volume adjustment key 105, a return key 106, a exit key 107, a move key 108, a enter (decision) key 109, a menu key 110, and an internet key 111 or the like.

The power source key 101 is a key for turning on/off the power source of the TV broadcast receiving apparatus 12. The one-touch channel selection key group 102 is a numeric key that is configured by 1 to 12 keys to be used for shifting a receiving channel or for inputting the numeric data. The receiving mode shift key group 103 is a key to shift the receiving mode upon watching the TV broadcast programs.

The channel up down key 104 is a key for selecting a TV channel by the up/down operation. The volume adjustment key 105 is a key to increase or reduce the volume. The return key 106 is a key to instruct to return to the last display state. The exit key 107 is a key to instruct to close the processing during execution.

The move key 108 is a key to select the items on the screen or to instruct movement of a cursor indicating a desirable position on the screen. The enter key 109 is a key to instruct registration of the item selected by the cursor. The menu key 110 is a key used to display a menu screen selecting various menus. The internet key 111 is a key used to start up an HTML browser.

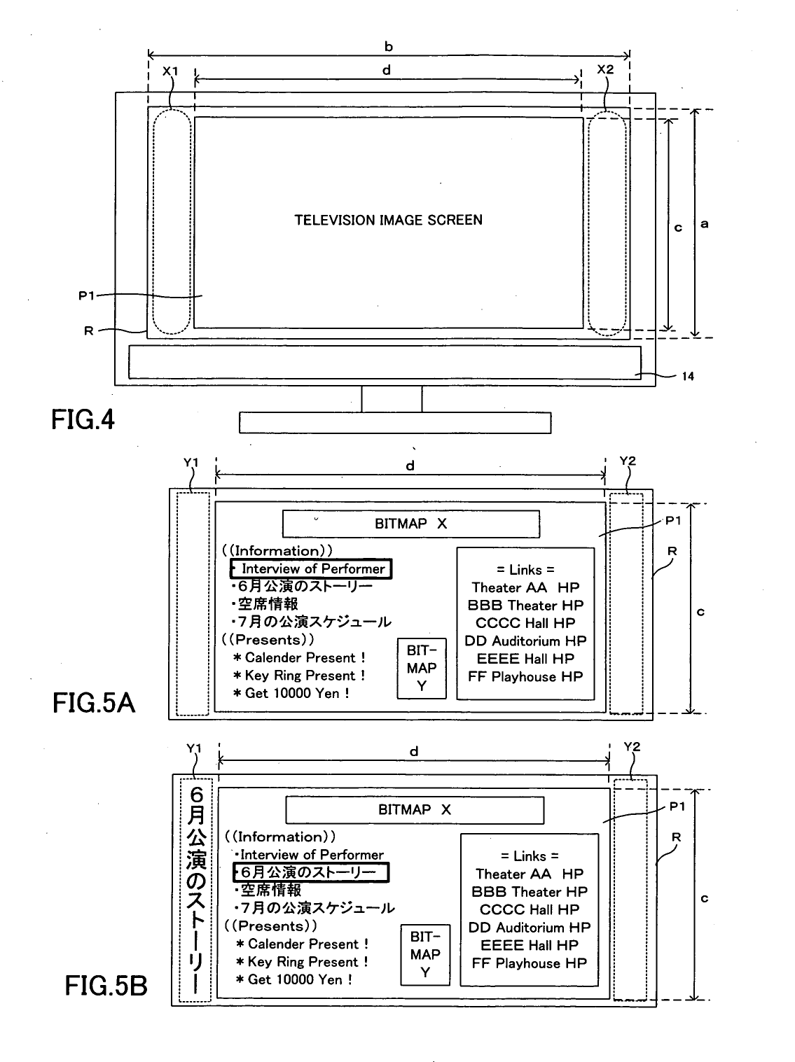

Referring to FIGS. 4 to 10, in the TV broadcast receiving system A and the TV broadcast receiving apparatus 12, the processing for enlarging the details of the web content so that the user can easily recognize it while maintaining the layout of the web content will be described below.

FIG. 4 to 9 are views showing the browser screen of the web content displayed on the monitor 13 and its enlarged display screen.

As shown in FIG. 4, the monitor 13 has a screen panel composed of a displayable region R (a height size a, a width size b: a<b). The displayable region R has an image display region P1 for displaying the TV picture image and image nondisplay regions X1 and X2 where the TV picture image are not displayed and the characters of the enlarged font size are displayable.

The monitor 13 is set that the image display region P1 (a height size c, a width size d: c<d, a>c, b>d) is smaller than the displayable region R in the screen panel. In the displayable region R of the monitor 13, the image nondisplay regions X1 and X2 are formed at right and left parts of the image display region P1. Such an orientation may be suitable for displaying text in a vertical format as shown for example in FIG. 5B. Alternatively, upper and lower horizontally oriented nondisplay regions may be used for displaying text in a horizontal orientation. The enlarging processing adapted to the monitor 13 having such a screen panel as shown in FIG. 4 will be described below.

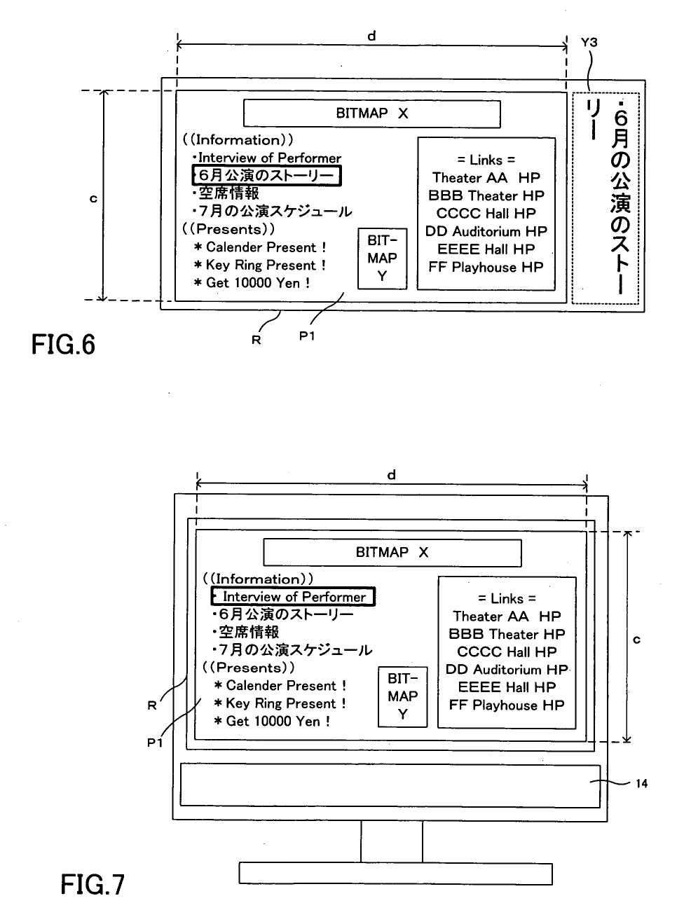

According to the present embodiment, as shown in FIG. 5(B) and FIG. 6, the browser screen is displayed on the image display region P1 of the monitor 13. Moreover, one of the image nondisplay regions X1 and X2 or both of them can be utilized as enlarging regions Y1 and Y2. Therefore the details of the web content displayed on the browser screen is enlarged on the image nondisplay regions X1 and X2 (that is the enlarging regions Y1 and Y2).

When the TV broadcast receiving apparatus 12 receives the user's instruction when the TV image screen is displayed on the monitor 13 as shown in FIG. 4, the display screen is switched in accordance with the user instruction. As the result, an initial screen of the web content is displayed on the monitor 13 as shown in FIG. 5(A), and then the item of “interviews of performers” in the web content is selected by the cursor.

From this initial screen display state, the user may move the cursor by using the move key 108 of the remote controller 16. Then, the TV broadcast receiving apparatus 12 judges the character of the moving destination of the cursor that is a target element to be enlarged on the basis of the operation information of this move key 108. As the result, as shown in FIG. 5(B), the TV broadcast receiving apparatus 12 displays the character of the moved destination of the cursor on the enlarging regions Y1 and Y2 in a larger font size.

In this case, the aspect ratio of the image display region P1 (a width size d, a height size c: a>c, b>d) is not changed. Accordingly, the aspect ratio and the entire layout of the web content displayed on the image display region P1 are not changed, so that the user can review the web content without any sense of discomfort and can easily recognize the location of the enlarged portion in relation to its position on the web page as a whole.

FIG. 6 is a view showing other example of the enlarging processing when the enlarging processing is adapted to the monitor 13 having the image nondisplay regions X1 and X2 as shown in FIG. 4.

According to the present embodiment, in the displayable region R of the monitor 13, a place displayed by the image display region P1 is moved horizontally by a prescribed amount. Therefore, the image nondisplay regions X1 and X2 are connected to each other on the same side of the display, so that the image nondisplay regions X1 and X2 are contiguous and can be utilized as a single enlarging region Y3.

In this case, the aspect ratio of the image display region P1 (a width size d, a height size c: a>c, b>d) is not changed. Moreover, it is possible to secure the range larger than the case shown in FIGS. 5A and 5B as the enlarging region Y3. Hence, the aspect ratio and the entire layout of the web content displayed on the image display region P1 is not changed, so that the user can review the web content without any sense of discomfort and can easily recognize the location of the enlarged portion in relation to its position on the web page as a whole.

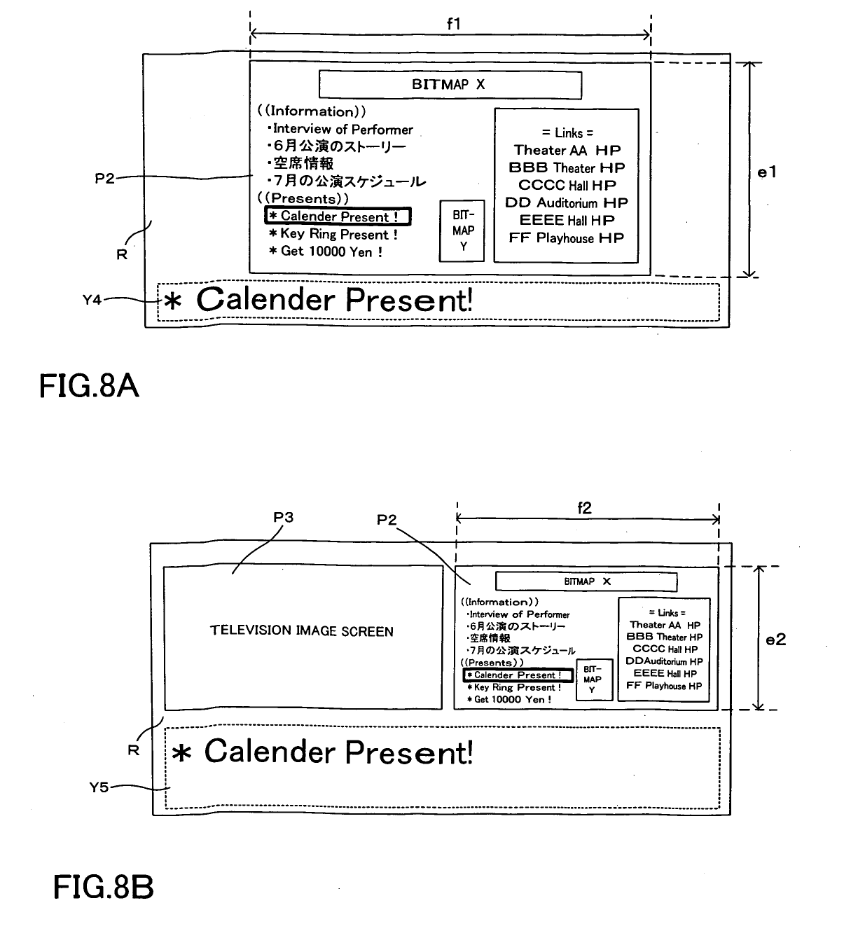

As shown in FIG. 7, the enlarging processing adapted to the monitor 13 having a screen panel which not capable of displaying characters of an enlarged font size at the right and left (or the upper and lower) parts of the image display region P1 (the height size c, the width size d: c>d) in the displayable region R will be described below. The display method shown in FIGS. 8A and 8B and FIG. 10 is also adaptable to the monitor 13 used in FIGS. 4 to 6.

According to the present embodiment, the usable image nondisplay range is not sufficient to display the desired enlargements of the selected sections of the web page. Therefore enlarging regions Y4, Y5, Y6, Y7 or Y8 are provided by reducing the size of the image display region P1 into a reduced image display region P2 (the width size f, height size e:e<f, c:d=e1:f1=e2:f2=e3:f3=e4:f4) without changing of the aspect ratio (d:c) of the image display region P1.

In FIG. 8(A), the reduced image display region P2 displaying the browser screen of the aspect ratio (d:c=f1:e1) is arranged at a center upper part in the displayable region R, so that the image nondisplay region formed at the lower part in the displayable region R is utilized as the enlarging region Y4 shaped as a horizontally long rectangle.

In FIG. 8(B), the reduced image display region P2 displaying the browser screen of the aspect ratio (d:c=f2:e2) and a reduced image display region P3 displaying the TV picture image are arranged side-by-side at the center upper part in the displayable region R, so that the image nondisplay region formed at the lower part in the displayable region R is utilized as the enlarging region Y5 shaped as a horizontally long rectangle.

In this case, since the TV picture image P3 is also displayed, the browser screen P2 is displayed smaller, so that the user can easily recognize the web content by enlarging the place designated by the user on the browser screen.

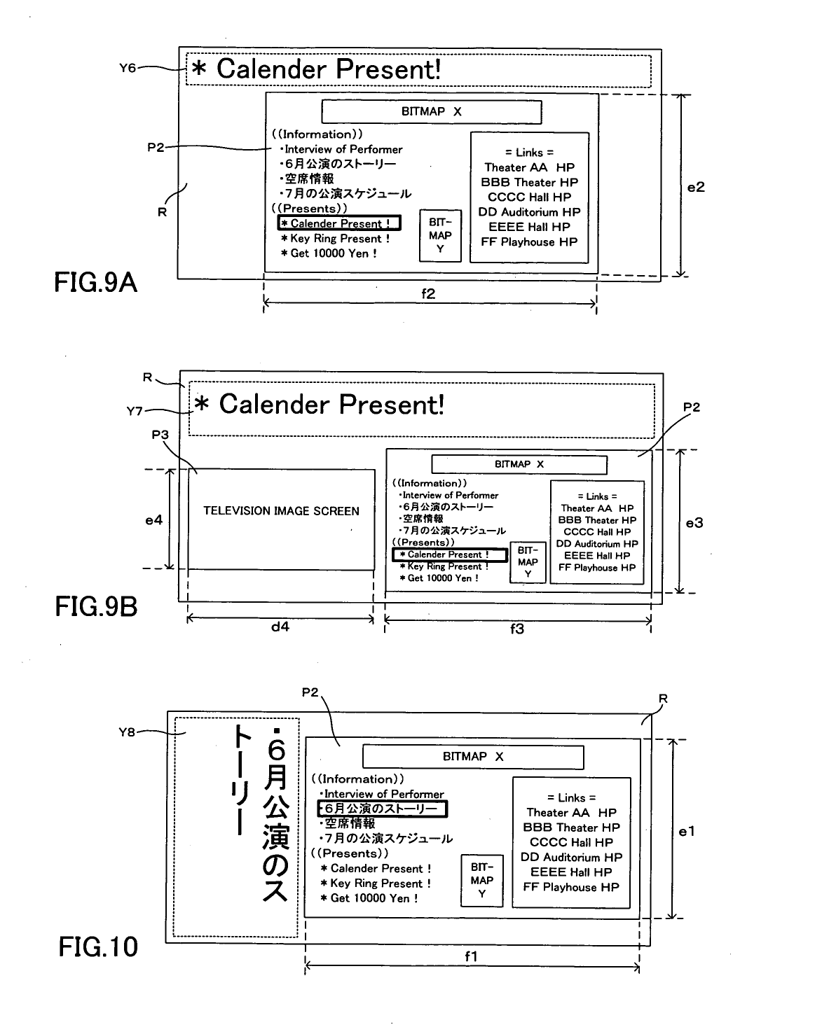

In FIG. 9(A), the reduced image display region P2 displaying the browser screen of the aspect ratio (d:c=f2:e2) is arranged at a center lower part in the displayable region R, so that the image nondisplay region formed at the upper part in the displayable region R is utilized as the enlarging region Y6 shaped as a horizontally long rectangle.

In FIG. 9(B), the reduced image display region P2 displaying the browser screen having the aspect ratio (d:c=f3:e3) and a reduced image display region P3 displaying the TV picture image are arranged side-by-side at the center upper part in the displayable region R, so that the image nondisplay region formed at the upper part in the displayable region R is utilized as the enlarging region Y7 shaped as a horizontally long rectangle.

In this case, since the TV picture image P3 is also displayed, the browser screen P2 is displayed smaller, so that the user can easily recognize the web content by enlarging the place designated by the user on the browser screen. In addition, the enlarging method shown in FIGS. 8A and 8B and FIGS. 9A and 9B is effective particularly in enlarging horizontally written characters in the web content.

In FIG. 10, the reduced image display region P2 displaying the browser screen of the aspect ratio (d:c=f1:e1) in the displayable region R is shifted from a center to a lateral direction to be arranged on one side portion, so that the image nondisplay region formed at other side portion is utilized as the enlarging region Y8 shaped as a horizontally long rectangle. The enlarging method shown in FIG. 10 is effective particularly in enlarging vertically written characters in the web content.

In other words, as shown in FIG. 7, it is assumed that the item of “interviews of performers” is selected by the cursor under the state that the initial screen of the web content is displayed on the monitor 13.

From this initial screen display state, the user may move the cursor by using the move key 108 of the remote controller 16. Then, the TV broadcast receiving apparatus 12 judges the characters highlighted by the moved cursor which is the target element to be enlarged on the basis of the operation information of this move key 108. As the result, the TV broadcast receiving apparatus 12 displays the character of the moved destination of the cursor on the enlarging regions Y4 to Y8 in a larger font size according to any enlarging method from among FIGS. 8 to 10.

Therefore, the enlarging regions Y4 to Y8 are provided by reducing the browser screen into the reduced image display region P2 (a width size f, a height size e: e<f, d:c=f1:e1+f2:e2=f3:e3=f4:e4) having the same ratio as the aspect ratio (d:c) of the image display region P1.

Hence, the aspect ratio and the entire layout of the web content displayed on the image display region P1 are not changed, so that the user can review the web content without any sense of discomfort and can easily recognize the location of the enlarged portion in relation to its position on the web page as a whole.

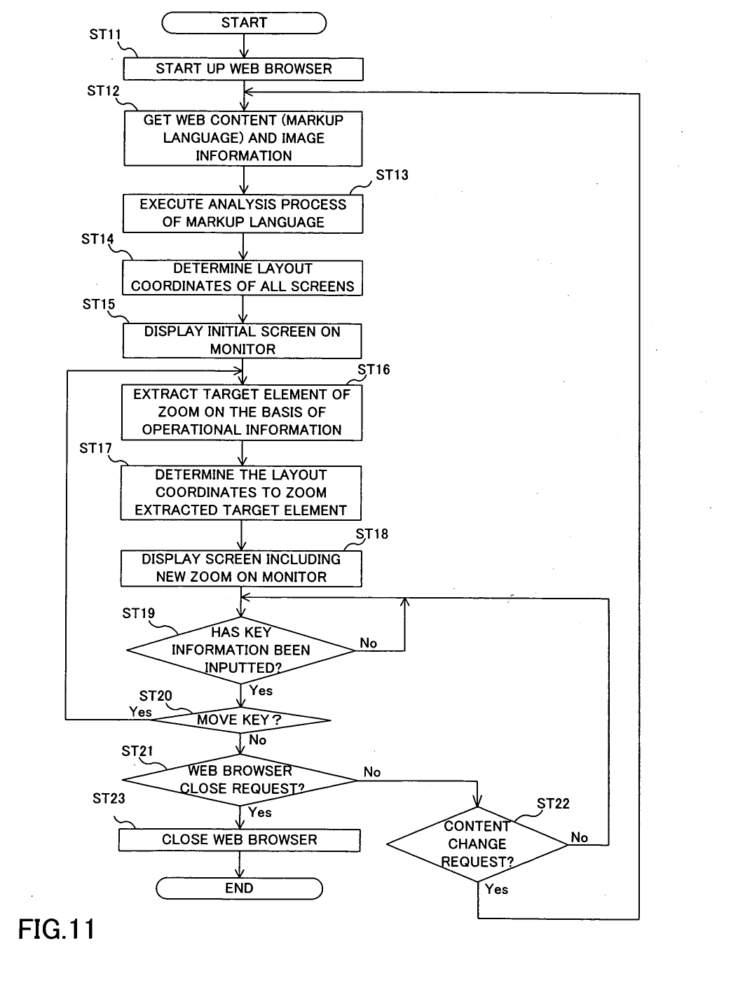

FIG. 11 is a flowchart showing a processing method for enlarging the details of the web content performed by the TV broadcast receiving apparatus 12.

In the TV broadcast receiving apparatus 12, a prescribed TV broadcast channel is selected on the basis of the channel selection operation by the user from the operation part (not illustrated) and/or the remote controller 16. Then, the image of that broadcast program is displayed on the monitor 13 and the sound is reproduced by the speaker 14 as shown in FIG. 4.

When the user selects the display of the web browser from the internet key 111 of the remote controller 16 (or comparable key on the operation part of the TV broadcast receiving apparatus 12, while watching a TV broadcast program, the control unit 27 performs starting up the web browser in response to the operation information related to starting up of the web browser that is inputted from the key processing unit 35 (step ST 11).

If the web browser is started in ST 11, the web browser processing unit 37 transmits the access request on the basis of the initialized URL information via the communication processing unit 32, and then obtains the web content (the markup language) and the image from the network 15 (step ST 12).

Then, the markup language processing unit 29 of the web browser processing unit 37 performs processes analyzing the markup language of the markup language obtained in ST 12, and outputs the analysis result to the layout display processing unit 28 (step ST 13).

Receiving the analysis result of ST 13, the layout display processing unit 28 determines layout coordinates of the all screens by using the font processing unit 34. Then, the layout display processing unit 28 generates the bitmap information, and outputs it to the output image processing unit 25. The layout display processing unit 28 generates a sound signal such as a sound effect and outputs it to the output sound processing unit 26 (step ST 14).

The output image processing unit 25 converts the bitmap information supplied from the layout display processing unit 28 into an image signal. Then, the output image processing unit 25 displays the image signal on the monitor 13 as the initial screen via the output terminal 41 as shown by FIG. 5(A) or FIG. 7 (step ST 15).

It is assumed that the user shifts the cursor by using the move key 108 of the remote controller 16 when the initial screen of the web content is displayed in ST 15. Then, the key processing unit 35 supplies the operational information corresponding to the move key 108 to the focus event processing unit 30.

The focus event processing unit 30 extracts the character of the moved destination of the cursor as a new target element of enlargement on the basis of the operational information corresponding to the inputted move key 108. Then The focus event processing unit 30 outputs this extracted information and the information to cause enlargement to the layout display processing unit 28 (step ST 16).

The layout display processing unit 28 determines the layout coordinates that are changed so as to enlarge the place corresponding to the extracted target element on the basis of the extraction information inputted from the focus event processing unit 30. The layout display processing unit 28 outputs the bitmap information thereof to the output image processing unit 25 (step ST 17).

The output image processing unit 25 converts the bitmap information supplied from the layout display processing unit 28 into the image signal. And then in response to the type of the monitor 13, as shown in any one of FIG. 5(B), FIG. 6, FIGS. 8A and 8B to FIG. 10, the output image processing unit 25 displays the web browser screen including the newly enlarged display on the monitor 13 (step ST 18).

If the user performs the key operation of the remote controller 16 under the display state of ST 18, the key processing unit 35 judges the operational information corresponding to the key operated by the user, and supplies this operational information to the control unit 27 and the focus event processing unit 30 (Yes of step ST 19).

If this operational information corresponds to the move key 108 (Yes of step ST 20), control returns to the processing of ST 16 in which the focus event processing unit 30 extracts the target element of the new enlarged display, and outputs it to the layout display processing unit 28 (step ST 16).

In addition, if the operational information is judged to require change of content (No in step ST 20, No in ST 21, Yes in ST 22), control is returned to the processing of ST 12 in which the web browser processing unit 37 transmits the access request on the basis of the new URL information via the communication processing unit 32 and obtains the web content (the markup language) and the image from the network 15 (ST 12).

In addition, if the operational information is judged to be the operational information other than change of content and closing of the web browser (No in step ST 20, No in ST 21, No in ST 22), control is returned to the processing of ST 19 in which the browser screen is placed in the stand-by state of the key operation by the user.

In addition, if the operational information is judged to request closing of the web browser (No in step ST 20, Yes in step ST 21), the control unit 27 closes the web browser (step ST 23), and as shown in FIG. 4, the control unit 27 starts to watch the TV broadcast program that was received before (i.e., before switching to web access.

As described above, according to the present embodiment, it is possible to enlarge the place designated by the user without changing the size or the width to height ratio (the aspect ratio) of the web browser screen that is originally displayed on the image display region.

Accordingly, since the displayed entire layout of the web content is not influenced (is not broken down), the user can review the web content without a sense of discomfort and can easily recognize the location of the enlarged portion in relation to its position on the web page as a whole. Thus, it is possible to greatly improve convenience of operation and viewing by the user.

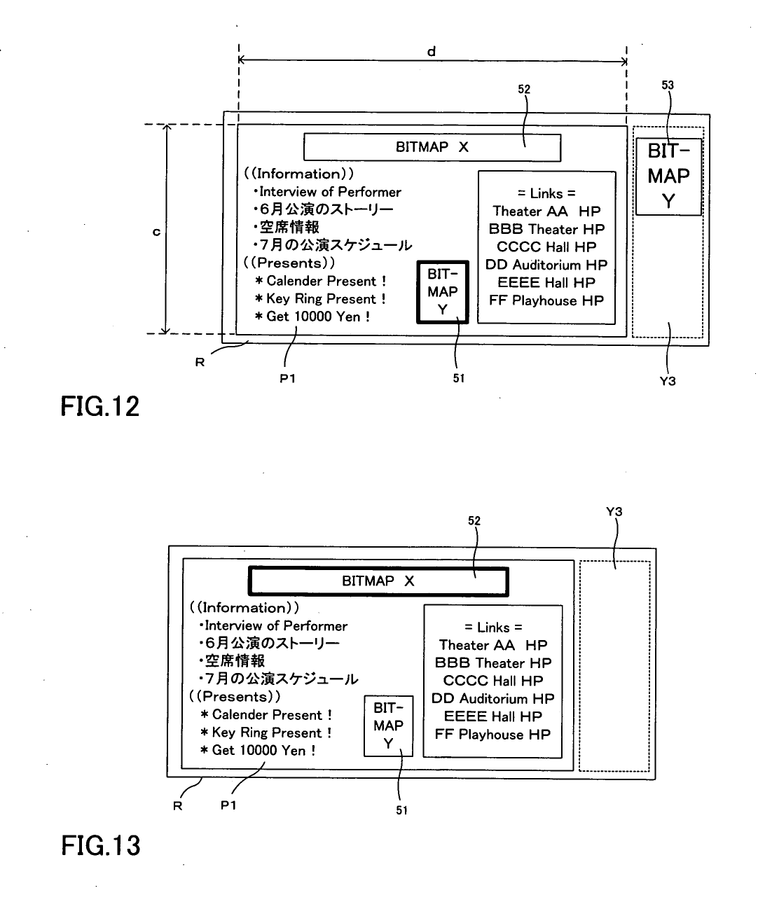

Next, with reference to FIGS. 12 to 17, a method to enlarge the bitmap image information located in the web content by the above-described TV broadcast receiving system A and the TV broadcast receiving apparatus 12 will be described below.

According to the present embodiment, the method to enlarge the bitmap screen in the case that the method is adopted to the monitor 13 set as the above-described enlargement screen shown in FIG. 6 will be explained, however, the present embodiment is not limited to this.

FIG. 12 and FIG. 13 are views showing an example of an enlarged screen displayed on the monitor 13. According to the present embodiment, the size of the bitmap image that can be enlarged in the enlarging region Y3 is limited in advance, and a reference value is stored in the memory 38 in advance.

In this case, it is defined that a size of a “bitmap Y” image 51 is in the range of the preset reference value, and a size of a “bitmap X” image 52 is beyond the range of this reference value.

If the user shifts the cursor by using the move key 108 of the remote controller 16 and the bitmap image is selected, the control unit 27 compares this bitmap image with the reference value stored in the memory 38. If the bitmap image is judged to be smaller than this reference value (namely, within a parameter), the control unit 27 converts the bitmap image to be enlarged and displays the enlarged bitmap image on the enlarging region Y3.

FIG. 12 shows the enlarged screen display of the monitor 13 when the user selects the “bitmap Y” image 51 by the cursor. As shown in FIG. 12, the size of the “bitmap Y” image 51 selected by the cursor is smaller than the reference value, namely, is within the parameter, so that an enlarged bitmap image 53 is displayed within the enlarging region Y3.

FIG. 13 shows the enlarged screen display of the monitor 13 when the user selects the “bitmap X” image 52 by the cursor. As shown in FIG. 13, the size of the “bitmap X” image 52 selected by the cursor is larger than the reference value, namely, is beyond the parameter, so that no image is displayed in the enlarging region Y3.

Thus, by setting the reference value of the bitmap image capable of being enlarged in advance in accordance with the size of the enlarging region, the user can easily recognize not only the text information but also the bitmap image information that is enlarged without changing the aspect ratio of the browser screen displayed on the image display region P1 and the entire layout of the web content.

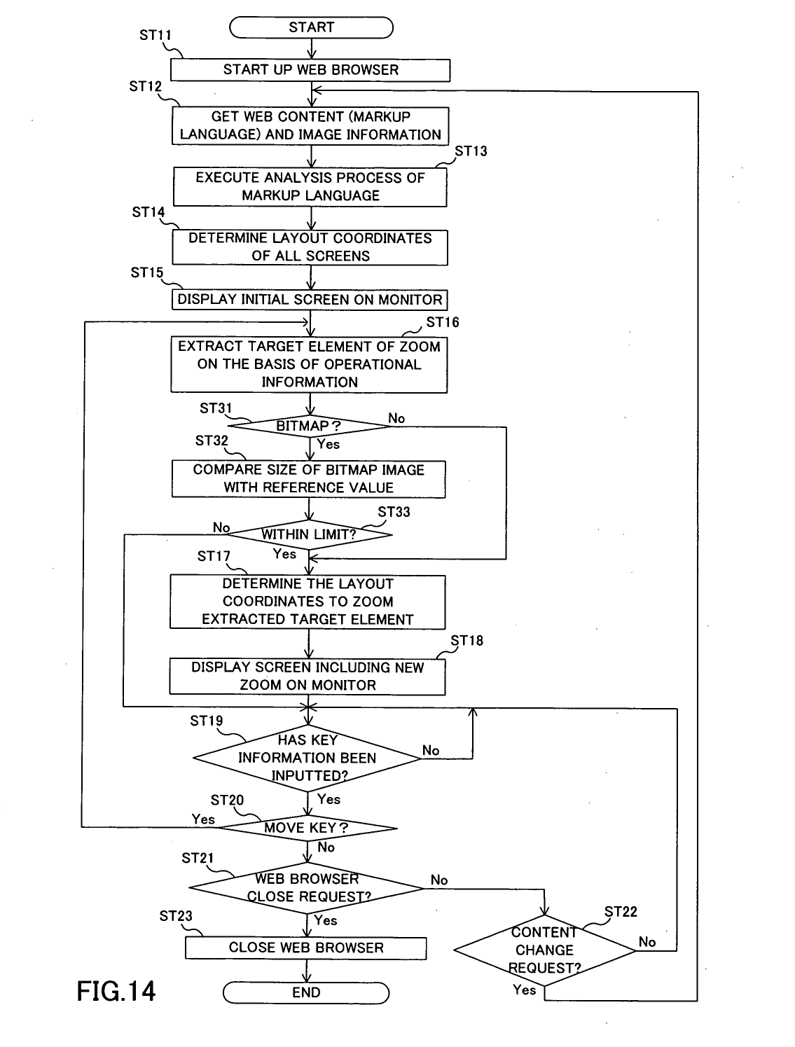

FIG. 14 is a flow chart for showing a processing method for enlarging the above-described bitmap image information of the web content in the TV broadcast receiving apparatus 12. The processing steps which are the same as those of the flow chart of FIG. 11 are given the same step numbers and the explanation of these processing steps are omitted.

In the TV broadcast receiving apparatus 12, if the web browser is started by the control unit 27 on the basis of the instruction of the user (ST 11), the web browser processing unit 37 obtains the web content and the image from the network 15 (ST 12), then performs processes analyzing the markup language (ST 13), and determines the layout coordinates of the entire screen (ST 14).

Then, according to the processing due to the output image processing unit 25, the initial screen of the web content converted into the image signal is displayed on the monitor 13 (ST 15).

If the user moves the cursor during displaying this initial screen, the focus event processing unit 30 extracts the moved destination of the cursor as a new target element for enlargement (ST 16).

When extracted destination in ST 16 is text information (No in step ST 31), the process goes to the processing step of ST 17, and the same processing as described in the flow chart shown in FIG. 11 will be carried out.

If the extracted destination in ST 16 is a bitmap image (Yes in step ST 31), the focus event processing unit 30 compares this extracted destination with the reference value having the predetermined size of the bitmap image, and determines whether the extracted destination is within the parameter of this reference value (step ST 32).

As a result of this detection, if the extracted destination is judged to be a bitmap image beyond the parameter (No in step ST 32), the process goes to the processing step of ST 19, and the browser screen goes into a stand-by state.

As a result of determination in ST 32, if the extracted place or destination is determined to be a bitmap image within the stored parameter value (Yes in ST 33), the focus event processing unit 30 outputs the extraction information corresponding to the bitmap image and the information instructing enlargement to the layout display processing unit 28.

The layout display processing unit 28 determines the layout coordinates that are changed so as to enlarge the place corresponding to the extracted target element on the basis of the extraction information inputted from the focus event processing unit 30 and outputs the bitmap information to the output image processing unit 25 (ST 17).

The output image processing unit 25 converts the bitmap information supplied from the layout display processing unit 28, and displays the web browser screen including a new enlarged display on the monitor 13 as shown in any one of FIGS. 12 to 15 (ST 18). Hereinafter, the same processing described in the flow chart shown in FIG. 11 will be carried out.

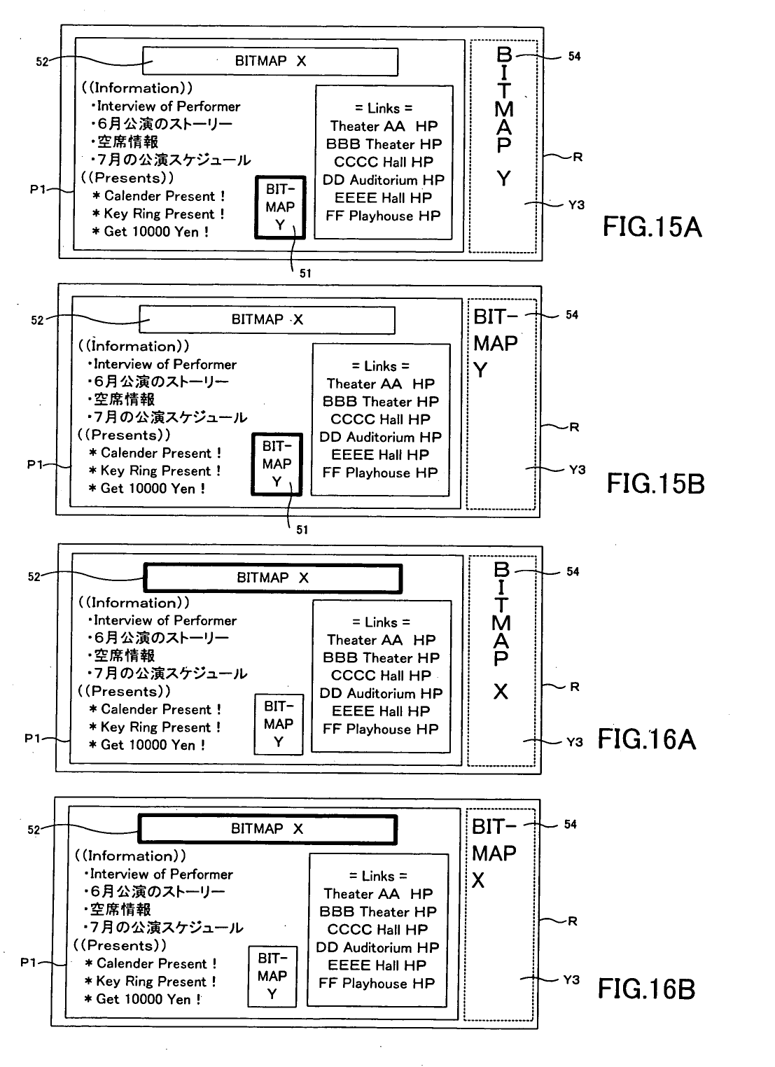

FIGS. 15 to 16 illustrate other example of the enlarged screen that is displayed on the monitor 13. According to an embodiment of the present embodiment, when the user selects the bitmap image by moving the cursor using the move key 108 of the remote controller 16, characters located in the selected bitmap image may be recognized by conventional character recognition software and the recognized characters are enlarged on the enlarging region and displayed as text.

In this case, the “bitmap Y” image 51 includes the image of the character as “bitmap Y” and the “bitmap X” image 52 includes the image of the character as “bitmap X”.

FIGS. 15A and 15B show the enlarged screen display of the monitor 13 when the user selects the “bitmap Y” image 51 by the cursor. As shown in FIG. 15B, if the “bitmap Y” image 51 is selected by the cursor, the character of “bitmap Y” located in the “bitmap Y” image 51 is recognized as character data and the recognized character data of “bitmap Y” is displayed as text on the enlarging region Y3 in an enlarged font size.

FIGS. 16A and 16B show the enlarged screen display of the monitor 13 when the user selects the “bitmap X” image 52 by the cursor. As shown in FIG. 16B, if the “bitmap X” image 52 is selected by the cursor, the character of “bitmap X” located in the “bitmap X” image 52 is recognized as character data and the recognized character data of “bitmap X” is displayed as text on the enlarging region Y3 in the enlarged font size.

As a result, not only the bitmap image including the text information, but also the character information located in the web content can be easily recognized by enlargement without changing the aspect ratio of the browser screen that is displayed on the image display region P1 and the entire layout of the web content.

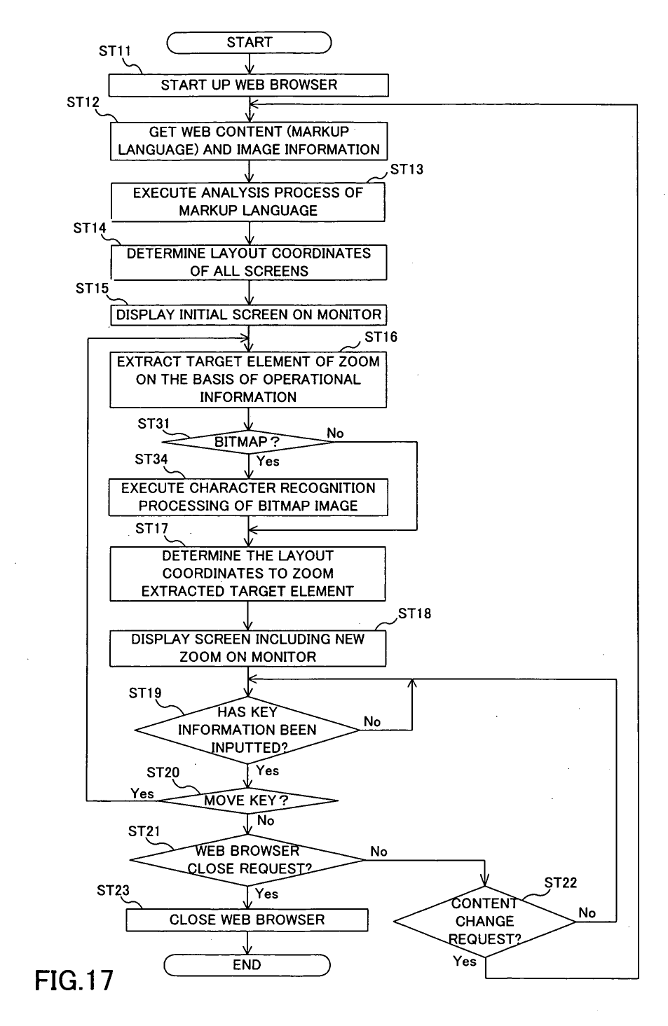

FIG. 17 is a flow chart for showing a processing method for enlarging the above-described bitmap image information of the web content in the TV broadcast receiving apparatus 12. The processing steps which are the same as those of the flow chart shown in FIG. 11 and FIG. 14 are given the same step numbers and the explanation of these processing steps are omitted.

In the TV broadcast receiving apparatus 12, if the user moves the cursor during displaying an initial screen in ST 15, the focus event processing unit 30 extracts the moved destination of the cursor as a new target element of enlargement (ST 16).

When this place extracted in ST 16 is text information (No in step ST 31), the program proceeds to the processing step of ST 17, in which the same processing as described in the flow charts shown in FIG. 11 and FIG. 14 is carried out.

When the place extracted in ST 16 is a bitmap image (Yes in step ST 31), the focus event processing unit 30 performs the character recognition processing with respect to the bitmap image. Then the focus event processing unit 30 extracts the character located in the bitmap image (step ST 34), and outputs this recognized character information and the information instructing the enlargement to the layout display processing unit 28. Then, proceeding to the processing step of ST 17, the same processing described in the flow charts shown in FIG. 11 and FIG. 14 will be carried out.

As described above, according to the present embodiment, it is possible to enlarge the bitmap image that is designated by the user in the web content without changing the size of the web content and without changing the size or the width and height ratio of the web browser screen that is originally displayed on the image display region.

Accordingly, since the entire displayed layout of the web content is not effected (is not broken down), the user can review the web content without any sense of discomfort and can easily recognize the location of the enlarged portion in relation to its position on the web page as a whole. As a result, it is possible to improve convenience of the user.

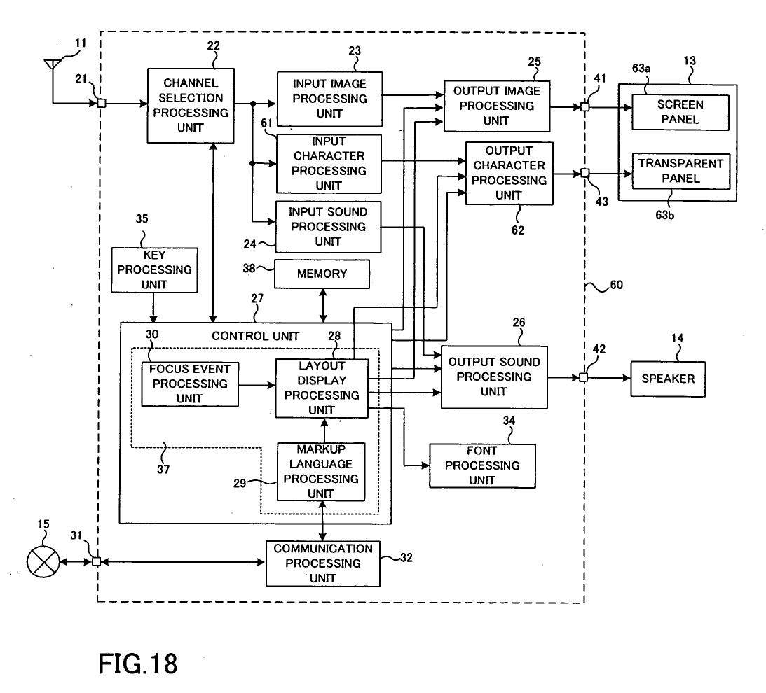

With reference to FIGS. 18 to 22, the processing for enlarging the details of the web content in a TV broadcast receiving apparatus 60 will be described below. FIG. 18 is a block diagram showing an embodiment of a configuration of a TV broadcast receiving apparatus 60, wherein the above-described configuration is partially modified (added). The functional blocks which are the same as those of the block diagram shown in FIG. 2 are given the same reference numbers and the explanation of these blocks are omitted.

According to the present embodiment, the monitor 13 as a display device that is connected to the TV broadcast receiving apparatus 60 with wires or by wireless means is configured in such a manner that a screen panel 63a composed of a CRT monitor or the like to display an image signal and a transparent panel 63b capable of displaying at least the text information on its upper surface overlap each other.

This transparent panel 63b is mainly adopted to display the character information such as a caption and a teletext broadcast, and if the text information is displayed on the transparent panel 63b, the text information is displayed so as to overlap the image screen displayed on the monitor 13.

As shown in FIG. 18, in the TV broadcast receiving apparatus 60, the channel selection processing unit 22 outputs the selected TV signal to the input image processing unit 23 and the input sound processing unit 24 respectively. And further, the channel selection processing unit 22 outputs a character signal related to the selected TV signal to a input character processing unit 61.

The input character processing unit 61 performs the decoding processing to the inputted character signal and outputs this character signal to an output character processing unit 62.

The focus event processing unit 30 extracts an element as a target of enlargement when the operational information corresponding to a key to which a designation function of enlarging is allocated (for example, the enter key 109) is inputted from the key processing unit 35 therein, and outputs this extraction information to the layout display processing unit 28.

The layout display processing unit 28 outputs the character information corresponding to the extraction information to the output character processing unit 62 on the basis of the analysis result inputted from the markup language processing unit 29 if the extraction information is inputted therein from the focus event processing unit 30.

The control unit 27 is further connected to the output character processing unit 62. The control unit 27 outputs control signal related to enlargement of the character to the output character processing unit 62 if the operational information corresponding to the key to which the designation function of enlarging is allocated is inputted from the key processing unit 35 therein.

The output character processing unit 62 converts the character information that is inputted from the layout display processing unit 28 into a enlarged character image signal on the basis of a control signal from the control unit 27, and outputs this character image signal to the transparent panel 63b, and then enlarges the character information.

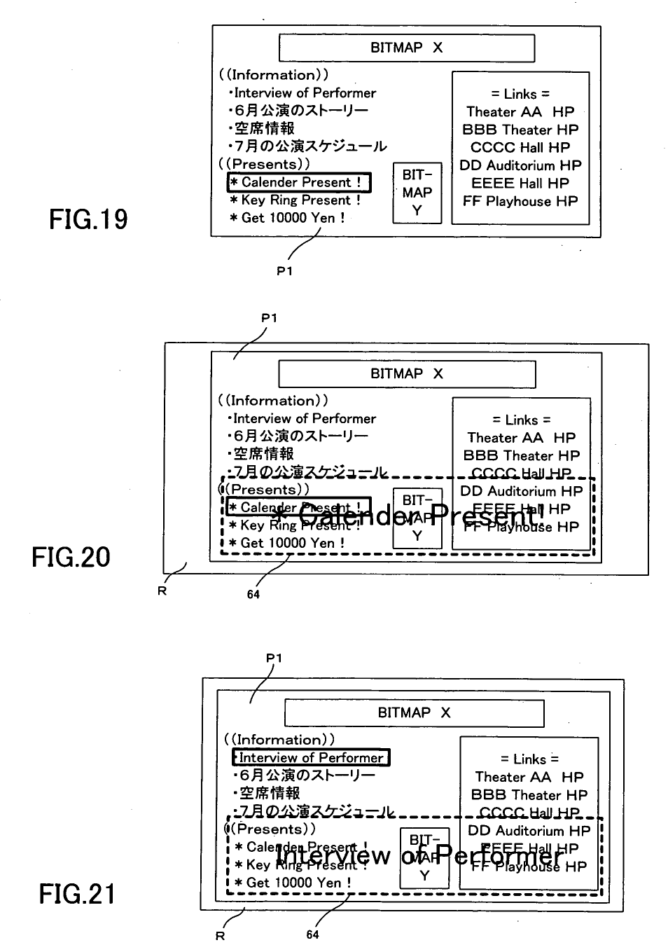

FIGS. 19 to 21 illustrate an example of the display screen wherein the web content is enlarged on the monitor 13 of the present embodiment and the character information is enlarged on the transparent panel 63b.

As shown in FIG. 19, when the screen of the web content is displayed on the monitor 13, the user operates a key to which a designation function of enlarging is allocated (for example, the enter key 109). Then, as shown in FIG. 20 and FIG. 21, the character information at the place that is selected by the cursor is enlarged on the prescribed display region 64 on the transparent panel 63b.

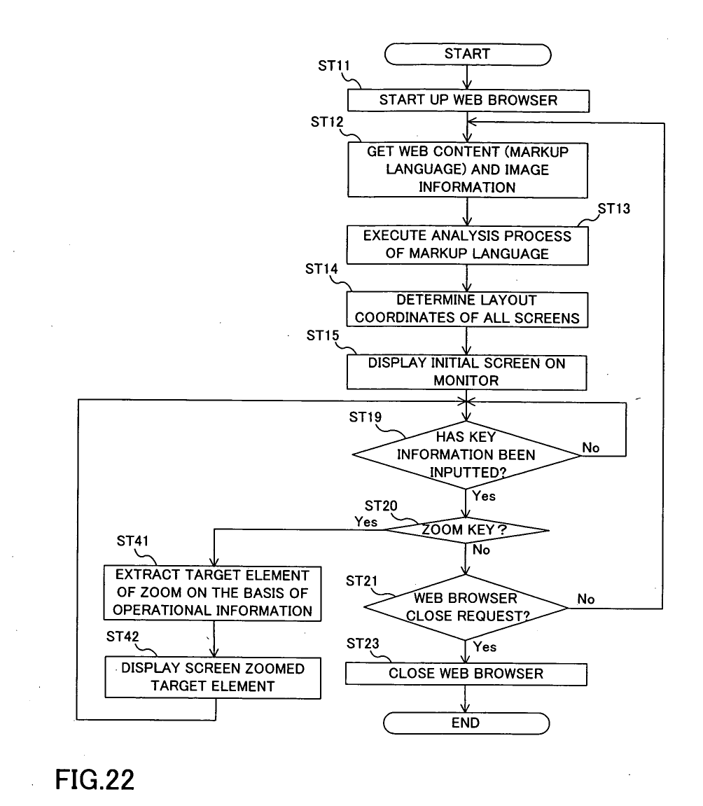

FIG. 22 is a flow chart showing a processing method for enlarging the above-described character information that is selected in the web content. The processing steps which are the same as those of the flow chart shown in FIG. 11 are given the same step numbers and the explanation of these processing steps are omitted.

In the TV broadcast receiving apparatus 12, if the web browser is started on the basis of the instruction of the user (ST 11), the web browser processing unit 37 obtains the web content and the image from the network 15 (ST 12), and performs processes analyzing the markup language (ST 13), and determines the layout coordinates of the entire screen (ST 14).

Then, according to the processing due to the output image processing unit 25, the initial screen of the web content converted into the image signal is displayed on the monitor 13 (ST 15).

Under the display state of ST 15, when the user performs the key operation of the remote controller 16, the key processing unit 35 judges the operational information corresponding to the key that is operated by the user and supplies this operational information to the control unit 27 and the focus event processing unit 30 (Yes in step ST 19).

If this operational information is judged to correspond to the instruction of enlarging (Yes in step ST 20), the focus event processing unit 30 extracts the selection destination of the cursor as a target element of enlarging, and outputs the extracted selection destination to the layout display processing unit 28 (step ST 41).

The layout display processing unit 28 outputs the character information corresponding to the extraction information to the output character processing unit 62. In addition, the control unit 27 outputs the control signal related to enlargement of the character to the output character processing unit 62 in response to the operational information of the key.

The output character processing unit 62 converts the character information that is inputted from the layout display processing unit 28 into the enlarged character image signal on the basis of the control signal from the control unit 27, and outputs the character image signal to the transparent panel 63b, which then displays the enlarged character information (step ST 42).

In addition, if the operational information is judged to be the operational information other than the key for indicating enlarging and closing of the web browser (No in step ST 20, No in ST 21), control returns to the processing of ST 19, and the browser screen goes into a stand-by state.

In addition, if the operational information is judged to request closing of the web browser (No in step ST 20, Yes in step ST 21), the control unit 27 closes the web browser (step ST 23), and controls the display of the TV broadcast program that was received before.

According to the present embodiment, by using the display device in which the screen panel 63a for displaying an image signal thereon and the transparent panel 63b capable of displaying at least the text information on its upper surface are arranged to overlap each other, the text portion of the web content that is selected by the cursor is enlarged on the transparent panel 63b in accordance with the designation of enlargement of the user.

Thus, without influencing the layout of the displayed web content, the user can review the web content and can recognize the portion designated by the cursor by enlarging that portion. As a result, it is possible to improve convenience of the user.

Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general invention concept as defined by the appended claims and their equivalents.

What is claimed is:

1. A TV broadcast receiving apparatus, connected to a display device having a screen panel, for displaying an image screen according to the received TV broadcast channel on the screen panel of said display device at a predetermined aspect ratio, comprising:
means for receiving a web content from an external server via a communication network;
means for generating a browser screen according to the web content that is received by said receiving means;
means for displaying the browser screen on said screen panel of said display device at said predetermined aspect ratio; and
means for controlling a display information to be enlarged and which is designated by a user on the displayed browser screen such that the enlarged information is displayed on a display area of said screen panel where said browser screen is not displayed while simultaneously displaying the browser screen generated by said generating means at said predetermined aspect ratio on said screen panel.

2. The TV broadcast receiving apparatus according to claim 1, wherein said control means controls the browser screen to be displayed by shifting the browser screen display to a position adjacent to one side of an external frame configuring said screen panel at said predetermined aspect ratio on said screen panel, and controls the enlarged information to be displayed on said display area where said browser screen is not displayed in said screen panel while displaying the shifted browser screen.

3. The TV broadcast receiving apparatus according to claim 1, wherein said control means controls the size of the browser screen generated by said generating means to be reduced without changing said predetermined aspect ratio, and controls the enlarged information to be displayed on said display area where said browser screen is not displayed by reducing said browser screen in said screen panel while displaying the reduced browser screen at said predetermined aspect ratio on said screen panel.

4. The TV broadcast receiving apparatus according to claim 1, wherein said control means comprises:
means for determining whether the display information that is designated by the user on said browser screen is composed of a bitmap image that is not beyond a predetermine size; and
means for controlling said bitmap image to be enlarged when said determining means determines that said bitmap image is not beyond said predetermine size, the enlarged bitmap image controlled to be displayed on a display area where said browser screen is not displayed in said screen panel while displaying the browser screen generated by said generating means at said predetermined aspect ratio on said screen panel.

5. The TV broadcast receiving apparatus according to claim 1, wherein said control means comprises:
means for determining whether the display information that is designated by the user on said browser screen is composed of a bitmap image that is not beyond a predetermine size;
means for extracting character information that is included in the bitmap image when said determining means determines that said bitmap image is not beyond said predetermine size; and
means for controlling said extracted character information to be enlarged such that the enlarged character information is displayed on a display area where said browser screen is not displayed in said screen panel while displaying the browser screen generated by said generating means at said predetermined aspect ratio on said screen panel.

6. A TV broadcast receiving system having a TV broadcast receiving apparatus for receiving TV broadcast channel signals and a display device having a first display panel which displays an image screen according to the received TV broadcast channel signals and a second display panel, being a transparent display panel that is disposed at a position at least partially overlapping said first display panel and displays character information based on said TV broadcast channel signals, comprising:
means for receiving a web content from an external server via a communication network;
means for generating a browser screen according to the web content that is received by said receiving means;
means for displaying the browser screen on said first display panel of said display device; and
means for controlling a display information designated by a user on said browser screen displayed on said first display panel when an instruction for enlarging is inputted from the user such that the display information designated by the user is enlarged and displayed on the second display panel overlapping said first display panel.

7. A display control method in a TV broadcast receiving apparatus connected to a display device having a screen panel for displaying an image screen according to the received TV broadcast channel on the screen panel of said display device at a predetermined aspect ratio, comprising the steps of:
receiving a web content from an external device;
generating a browser screen according to the web content that is received from the external device;
displaying the generated browser screen on said screen panel at said predetermined aspect ratio;
controlling a display information to be enlarged and which is designated by a user on said displayed browser screen; and
displaying said enlarged display information on a display area of said screen panel where said browser screen is not displayed while simultaneously displaying the browser screen.

8. The display control method according to claim 7, further comprising the step of displaying said browser screen at a position adjacent to one side of an external frame of said display device, displaced from a central position and being displayed at said predetermined aspect ratio.

9. A display control method in a TV broadcast receiving apparatus connected to a display device having a screen panel for displaying an image screen according to the received TV broadcast channel on the screen panel of said display device at a predetermined aspect ratio, comprising the steps of:
generating a browser screen according to a web content that is received from an external server via a communication network;
displaying on said screen panel the generated browser screen with a reduced size without changing said predetermined aspect ratio; and
controlling a display information that is designated to be enlarged by a user on said displayed browser screen such that said enlarged display information is displayed on a display area of said screen panel where said browser screen is not displayed and said browser screen is simultaneously reduced in size and displayed on said screen panel at said reduced size and at said predetermined aspect ratio.

10. The display control method according to claim 7, further comparing the steps of:
determining whether the display information that is designated by the user on said browser screen is composed of a bitmap image that is not beyond a predetermine size; and
enlarging said bitmap image when said determining step determines that said bitmap image is not beyond a predetermine size so that the enlarged bitmap image is displayed on said display area where said browser screen is not displayed in said screen panel while simultaneously displaying the displayed browser screen.

11. The display control method according to claim 7, further comprising the step of:
determining whether the display information that is designated by the user on said browser screen is composed of a bitmap image that is not beyond a predetermine size;
extracting character information that is included in the bitmap image when said determining step determines that said bitmap image is not beyond a predetermine size; and
enlarging said extracted character information so that the enlarged character information is displayed on said display area where said browser screen is not displayed in said screen panel while simultaneously displaying the browser screen.

12. A display control method in a TV broadcast receiving system having a TV broadcast receiving apparatus, connected to said TV service receiving apparatus, for receiving TV broadcast channel signals and a display device having a first display panel which displays an image screen according to the received TV broadcast channel signals and a second display panel, said second display panel being transparent and disposed at least partially overlapping said first display panel and displaying the character information, comprising:
generating a browser screen according to a web content that is received from an external device;
displaying the generated browser screen on said first display panel, and
enlarging an information designated by a user on said browser screen displayed on said first display panel when an instruction for enlarging is inputted from the user so that the enlarged information is displayed on the second display panel.

13. A TV broadcast receiving apparatus, connected to a display device having a screen panel, for displaying an image screen according to the received TV broadcast channel on the screen panel of said display device at a predetermined aspect ratio, comprising:
a receiver for receiving a web content from an external server via a communication network;
a web browser for generating a browser screen according to the web content that is received by said receiver;
a display controller for displaying the browser screen on said screen panel of said display device at said predetermined aspect ratio; and
a controller for controlling a display information to be enlarged and which is designated by a user on the displayed browser screen such that the enlarged information is displayed on a display area of said screen panel where said browser screen is not displayed while simultaneously displaying the browser screen generated by said display controller at said predetermined aspect ratio on said screen panel.

14. A TV broadcast receiving system having a TV broadcast receiving apparatus for receiving TV broadcast channel signals and a display device having a first display panel which displays an image screen according to the received TV broadcast channel signals and a second display panel, being a transparent display panel that is disposed at a position at least partially overlapping said first display panel and displays character information based on said TV broadcast channel signals, comprising:
a receiver for receiving a web content from an external server via a communication network;
a web browser for generating a browser screen according to the web content that is received by said receiving means;
a display controller for displaying the browser screen on said first display panel of said display device; and
a controller for controlling a display information designated by a user on said browser screen displayed on said first display panel when an instruction for enlarging is inputted from the user such that the display information designated by the user is enlarged and displayed on the second display panel overlapping said first display panel.

15. A processing apparatus for a TV broadcast receiving apparatus which is connected to a display device having a screen panel, for displaying an image screen according to a received TV broadcast channel and a web browser on the screen panel of said display device at a predetermined aspect ratio, comprising:
a display controller for displaying a browser screen of the web browser on said screen panel of said display device at said predetermined aspect ratio; and
a controller for controlling a display information to be enlarged and which is designated by a user on the displayed browser screen such that the enlarged information is displayed on a display area of said screen panel where said browser screen is not displayed while simultaneously displaying the browser screen generated by said display controller at said predetermined aspect ratio on said screen panel.

16. The apparatus as recited in claim 15 wherein said controller is operable to display said enlarged information and to simultaneously displaying said image screen according to said received TV broadcast channel and to display said browser screen, each at said predetermined aspect ratio.
